(19) United States
(12) Patent Application Publication
(10) Pub. No.: US 2014/0372197 A1
(43) Pub. Date: Dec. 18, 2014

(54) SYSTEMS, APPARATUSES AND METHODS FOR PROVIDING A PRICE POINT TO A CONSUMER FOR PRODUCTS IN AN ELECTRONIC SHOPPING CART OF THE CONSUMER

(71) Applicant: Tigerapps, Irvine, CA (US)

(72) Inventors: Farid Muhammad, Dana Point, CA (US); Ahmad Khatib, Huntington Beach, CA (US)

(21) Appl. No.: 13/918,524

(22) Filed: Jun. 14, 2013

(51) Int. Cl. G06Q 30/02; G06Q 30/06

(52) U.S. Cl. CPC G06Q 30/0233; G06Q 30/0643; G06Q 30/0633
USPC 705/14.33

(57) ABSTRACT

Systems, apparatuses and methods for dynamic targeting of advertising campaigns to consumers are described, which systems, apparatuses and methods may enable a merchant to offer an exclusive price point to one or more consumers that may be particularly receptive to the exclusive price point. An example system for providing an exclusive price point to a consumer for products in an electronic shopping cart of the consumer includes a processor, storage, and memory with instructions for hosting an electronic marketplace, gathering and generating product and consumer data, and/or providing affinity data to a merchant for use in targeting an advertising campaign.

### TECHNICAL FIELD

Examples described herein relate generally to electronic commerce (“e-commerce”) systems, and in some examples more specifically to systems, methods and apparatuses for providing a customized or an exclusive price point to a consumer or multiple consumers for one or more products available for purchase by the consumer through an electronic marketplace.

### BACKGROUND

Social networks (e.g., Facebook, Twitter, Instagram) in which users can friend, communicate electronically with, and share content with others have become ubiquitous in our everyday lives. These social networks are generally web-based, allowing users to communicate over the internet and/or using wireless communication devices. Internet-based advertising has also become ubiquitous (e.g., AdChoice, AdWords and other sponsored advertising). Certain internet-based advertising may be based on search words entered by a user in web search engine. Others may be based on websites you have visited in the past. Typically cookies are used to monitor and store information about the user's internet activities and this information may be used by internet-based advertisers to tailor ads to the user's browsing history. However, currently known web-based advertising systems may have limited payoff potential because ads are tailored based on the user's browsing activity which may or may not reflect the user's true likes and dislikes. Moreover, currently known web-based advertising tools do not permit interaction with the user. As such, only limited information may be available to the advertiser and the advertiser or merchant may not have adequate information or ability to tailor advertising campaign so as to optimize payoff.

Still further, social networking sites may allow users to demonstrate affinity for other products, pages, or other items using ‘likes’ or other mechanisms of affinity identification. However, the ability for a product vendor to capitalize on the social networking site's audience is typically limited to the appearance of ads. It may be difficult or inefficient to monetize the ‘likes’ a vendor receives.

### BRIEF DESCRIPTION OF THE DRAWINGS

FIG. 1 is a block diagram of a system according to the present disclosure;

FIG. 2 is a block diagram of an example of a supplier device to according to the present disclosure;

FIG. 3 is a block diagram of an example of a user device according to the present disclosure;

FIG. 4 is block diagram of another device according to an example of the present disclosure;

FIG. 5 is an illustration of analytics which may be generated by a system according to the present disclosure;

FIGS. 6(1)-6(2) show a process diagram according to one example herein; and

FIG. 7 is an illustration of another example of analytics which may be generated by a system according to the present disclosure.

### DETAILED DESCRIPTION

Certain details are set forth below to provide a sufficient understanding of embodiments of the invention. However, it will be clear to one having skill in the art that embodiments of the invention may be practiced without these particular details. Moreover, the particular embodiments of the present invention described herein are provided by way of example and should not be used to limit the scope of the invention to these particular embodiments.

The present disclosure describes examples of systems, methods, and apparatuses for implementing a social media electronic marketplace. Examples according to the present disclosure may enable a marketing partner (e.g., a supplier) to offer goods and/or services to a member or user of the electronic marketplace (e.g., a customer) at a customized or exclusive price point. A system according to some examples herein may function as an intermediary or facilitator between the supplier, which may be, for example an online retailer, merchant, vendor, seller, or provider, and the customer, who may be for example a consumer, buyer, purchaser, user, or subscriber. While specific examples are described in the context of retailing goods such as clothing, the social media electronic marketplace described herein may be utilized for virtually any consumer/seller relationship. For example, the consumer or customer may be a subscriber to a service provided by a service provider, for example a provider of online content. Products, e.g. items, available in the electronic marketplace may include any type of product, content, services, or other tangible or intangible offerings of one or more suppliers.

The systems and methods described herein may be utilized to allow the supplier to intelligently and dynamically adjust price points of offerings of its products for an individual customer or particular groupings of customers. The examples herein may enable marketing partners of the electronic marketplace to identify customers' “strong likes”, “likes”, and/or desire to purchase an item and to intelligently target advertising campaigns based on requests to solicit an exclusive price point received from customers. In this regard, an electronic marketplace according to the examples herein may enable a shift from a traditional “push” model for advertising and marketing of goods and services to an intelligent “pull” method for advertising goods/services, in which marketplace the customer's preferences, likes/dislikes, and/or explicit or tacit indications of a desire to purchase a product, as well as the customer's underlying shopping behavior and/or other activity within the marketplace, may assist the merchant in customizing or personalizing a price point at which the merchant is willing to offer the product to the customer. A customer who receives an exclusive price point may elect to use the exclusive price point to purchase the product, “gift” the exclusive price point to another customer (e.g., another member of the shared marketplace), or take no action and allow the offer to expire. Generally, an exclusive price point may be available to a user for only a limited time and for only a single use. As such, certain limitations imposed on the exclusive price point may generate “positive tension” of the shopping experience for the consumer and/or incentivize the consumer to complete the transaction or “gift” the offer in timely manner (e.g., before the expiration the exclusive price point). An exclusive price point generally refers to a price point offered by a supplier specifically to a customer or group of customers. The exclusive price point may be a different price point than generally offered to the public who may not have demonstrated affinity for the product, the supplier, or otherwise met the supplier's criteria for receipt of the exclusive price point. While generally, an exclusive price point may be a lower price point than typically available, in some examples the exclusive price point may be a higher price point (e.g., if the supplier believes a higher price point may be attainable with a particular customer or group of customers).

Systems described herein may include a customer portal for allowing a customer to interact with information displayed on by an intermediary system (e.g., on a web-based shopping site), and a supplier portal to allow a supplier to upload information about its products, monitor sales performance of its products, and/or monitor user interaction with information about the products and further tailor marketing campaigns to a particular customer, for example based on the customer's activity on the intermediary system (e.g., web site). Without being limiting, examples of a systems and methods described herein are provided in the context of online retail of clothing, accessories, or other fashion items. Other items may be for sale in other examples.

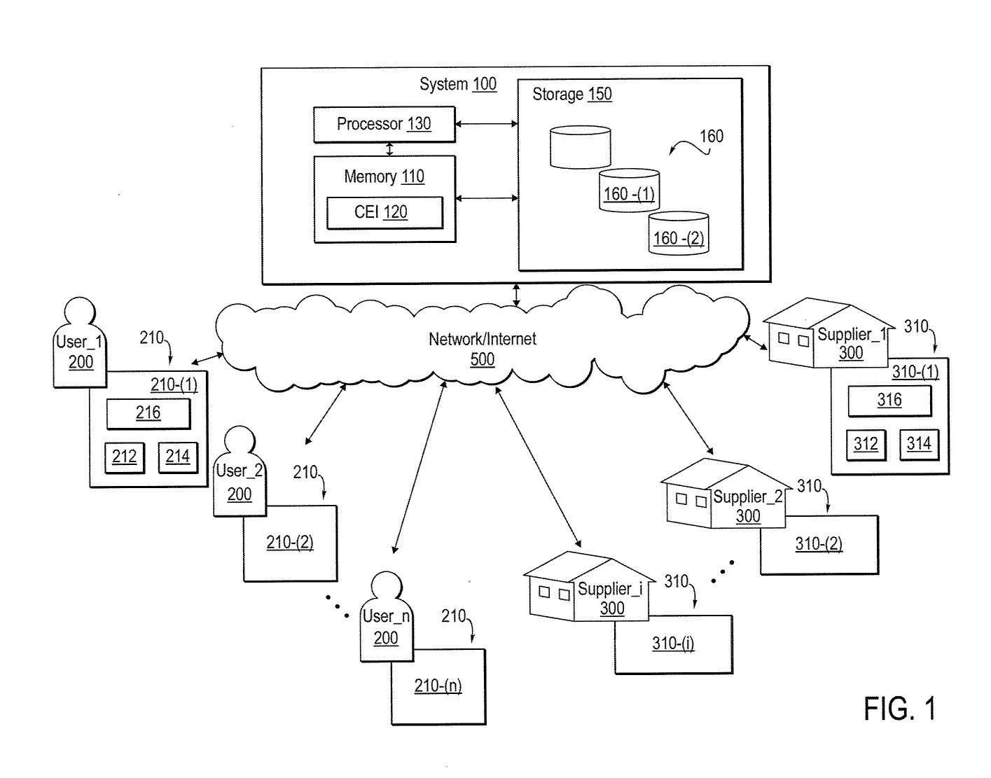

FIG. 1 is a schematic diagram of a system 100 according to one embodiment of the present disclosure. The system 100 may be a network-based or web-based system which may enable a supplier 300 to offer an exclusive price point to a customer 200. The system 100 may in this regard serve as an intermediary or facilitator between the supplier and the customer. Accordingly, the system may interchangeably be referred to herein as facilitator system 100 or simply intermediary or facilitator. The system 100 may exchange data with one or more supplier clients 300 and one or more customer clients 200 over the network 500, which may be the Internet.

The system 100 may be implemented using a memory 110 which may be encoded with computer executable instructions 120 that are capable of being executed by one or more processing unit(s) 130. The memory 110 may be implemented using any transitory or non-transitory computer readable medium or multiple computer readable media, including but not limited to, hard disks, RAM, ROM, flash, optical storage, or any other electronic storage. The processing unit(s) 130 may be implemented using one or more processor(s) or other circuitry capable of performing the described functions. While shown as a single memory 110 and processor 120, it is to be understood that the architecture of the system 100 is flexible, and multiple processors and/or memories may be used to encode and execute the described instructions. The memory and/or processor(s) may further be distributed across one or more physical computing devices or locations in some examples. Accordingly, the system 100 may include a computer or computers programmed to perform any or all of the functions described with regard to the instructions encoded on the memory 110. The system 100 may also include or be communicatively coupled to one or more storage devices collectively referred to as storage 150. The storage 150 may include one or more databases 160 configured to store information as will be further described.

As noted above, the system 100 may be in electronic communicating with one or more user devices 210 and one or more supplier devices 310. Any number of user devices and any number of supplier devices may be communicatively connected to system 100 at any given time via the network 500. For example, a user device 210-(1) may be associated with a first user, user_{—}1, a second user device 210-(2) may be associated with a second user, user_{—}2, and so on (e.g., user device 210-(n) may be associated with a n-th user, user_n). In some examples two or more users may communicate with the system 100 using the same user device, for example a unique user session may be established in the memory 110 of the system 100 responsive to inputs (e.g., authentication information) provided by the one or more users at any given time. The user device may include any electronic device which includes a display and is enabled to receive input from the user and for communicating over the network 500. For example any of the user devices 310 may be a computing device, including but not limited to a modem, a router, a gateway, a server, a thin client, a laptop, a desktop, a computer, a tablet, a media device, a smart phone, cellular phone or other mobile device, or any combination or sub-combination of the same. The user device 210 may include a computer readable medium 212 (or multiple computer readable media) encoded with executable instructions which when executed by a processor 214 (or multiple processors) of the user device 210 cause the device to exchange information with the system 100 and/or display information on a display 216 of the user device.

As will be understood, the network 500 may be implemented using one or more networks, such as local area networks (LANs), wide area networks (WANs), metropolitan area networks (MANs), cellular networks, and/or the Internet. Communications provided to, from, and within the network 500 may wired and/or wireless, and further may be provided by any networking devices known in the art, now or in the future. Devices communicating over the network 500 may communicate with any communication protocol, including, but not limited to, TCP/IP, UDP, RS-232, and IEEE 802.11.

One or more supplier devices 300 may be in communication with the system 100 at any given time via the network 500, which may be the Internet. For example, supplier device 310-(1) may be associated with a first supplier 300-(1), supplier device 310-(2) may be associated with a second different supplier 300-(2), and so on. The supplier device 310 may include computer readable medium 312 (or multiple computer readable media) having executable instructions stored therein, and a processor 314 (or multiple processors) for executing the instructions to cause the supplier device 310 to communicate with the system 100 and/or display information on a display 316 of the supplier device. The supplier device 310 may be implemented as a computing device, including but not limited to a modem, a router, a gateway, a server, a thin client, a laptop, a desktop, a computer, a tablet, a media device, a smart phone, cellular phone or other mobile device, or any combination or sub-combination of the same.

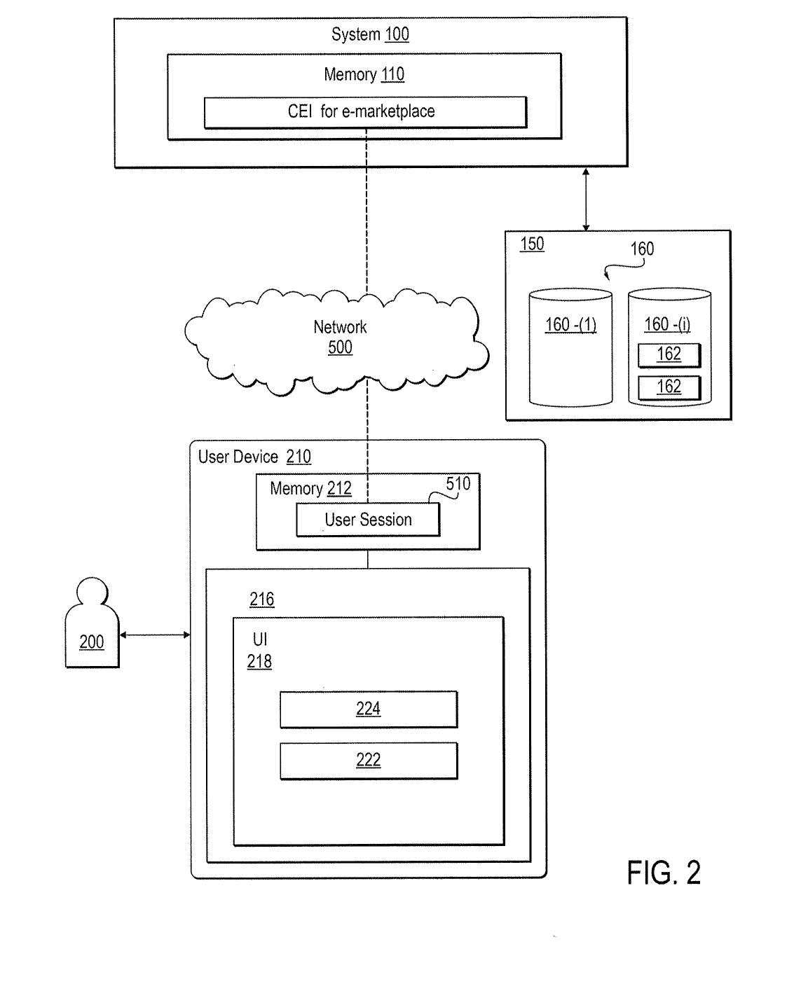

To facilitate an understanding of the present disclosure, an example of a system during normal operation according to the present disclosure will now be described in further detail with reference to FIGS. 2-7. FIG. 2 illustrates an embodiment according to the present disclosure. During operation, the system 100 may host an electronic marketplace 500 according to the examples herein. A user session 510 of the electronic marketplace 500 may be established in the memory 212 of the user device and information may be exchanged between the user device 210 and the system 100 for the duration of the user session. A user interface 218 may be displayed during the user session. The user interface 218 may be web-based (e.g., using any conventional web browser such as Internet Explorer, Firefox, Chrome, Safari, or the like) or it may be a dedicated graphical user interface (GUI) configured for user interaction with the system 100. For example, the user interface 218 may be provided by an application available on a tablet, mobile phone, or other user device. During the user session 510, a user may interact within the electronic marketplace hosted by system 100, for example to rate products available for purchase through the electronic marketplace 500, share products with other members of the electronic marketplace 500, and/or place products in the user's electronic shopping cart. A “request for offer” feature may be triggered in response to the user placing the product in his shopping cart, and used by the system for tailoring advertising campaigns as will be further described. The user may view and/or add content pertaining to the products, which content may be shared with other members of the electronic marketplace 500. For example, if a user likes an item that is available for purchase and/or the user has purchased or otherwise owns the item, the user can upload a user-created picture of the item (e.g., a picture of the user wearing the clothing item).

As discussed, the system may be communicatively coupled to any number of users. Information about each user may be stored in a user database 160-(1). Information about each user may be arranged in any suitable logical structure of the user database 160-(1), including but not limited to a vector, a matrix, or any other suitable data structure. Information about a user may collectively be referred to herein as a user profile 162, which may include attributes or features of the user as well as preferences for the user. The attributes of the user may pertain to characteristics or features of the user as well as information received from the user through interaction of the user with the electronic marketplace. For example, the attributes or features of the user, also referred to herein as user features, may include without being limited to sex or gender, age, location, membership date, average rating, average money spent per purchase, amount spent in a given period of time (e.g., last week, last month, over a three month period, etc.), largest amount spent at one time, smallest amount spent at one time, number of items purchased at one time, number of items purchased since joining, number of items rated, number of items viewed, time spent in the marketplace, and others. Certain ones of the user features may be provided by the user via the user interface 218, while other ones of the user features may be generated by the system 100. The user features may be updated over time based on user interactions within the electronic marketplace 500.

As described above, a “request for offer” feature may also be included in the user's profile for any or all of the items in the marketplace, which feature may be used to allow suppliers to target offer to certain groups of users. In some embodiments, the “request for offer” feature may have a binary value such that the “request for offer” feature may be toggled from an ON state (e.g., a state having a positive value) to an OFF or null state as the user places and removes, respectively, the item into and from his electronic shopping cart 222. In the context of the present disclosure, the electronic shopping cart 222 of the user may contain items which the user may be very interested in and/or may desire to purchase. As long as an item remains in the shopping cart 222 of the user, the “request for offer” feature of the user and associated with that particular item may remain in an ON state. The “request for offer” features of users may be used, as will be further described, to allow suppliers to intelligently target advertising campaigns to users who have indicated a desire to purchase items of the supplier. So for example, when a user places an item in a shopping cart, or otherwise indicates an affinity for the item, a field in a database entry relating to that user and/or that product, or the combination, may take on a value indicative of a request for offer. This may indicate to a supplier that the user would be receptive to an exclusive price point and/or indicate to the supplier a higher likelihood of converting the exclusive price point to a sale.

The preferences for the user may pertain to likelihood that a user may like an item in the electronic marketplace. As such, the preferences may be updated continuously or periodically based on user interaction with the electronic marketplace 500. The preferences may be arranged, in some embodiments, in vector form with an entry provided for each product item available for sale in the electronic marketplace 500. In some examples, certain values in the preferences vector may be user provided, for example if the user has rated an item, and certain values may be predicted by a recommendation methodology implemented by the system 100 as will be further described below.

Referring back to FIG. 2, during a user session, the user 200 may interact with the electronic marketplace 500 by providing inputs via the user interface 218. Information responsive to user inputs may be displayed in the display 216 of the user device 210. For example, the user may receive product information pertaining to recommendations for items from the system 100. The product information may be displayed in a recommendation window 224, and the product information may include pictures, descriptions and/or any suitable audio-visual information pertaining to the recommended products. The user 200 may rate, share, and/or place items from the recommended items in the user's electronic shopping cart 222.

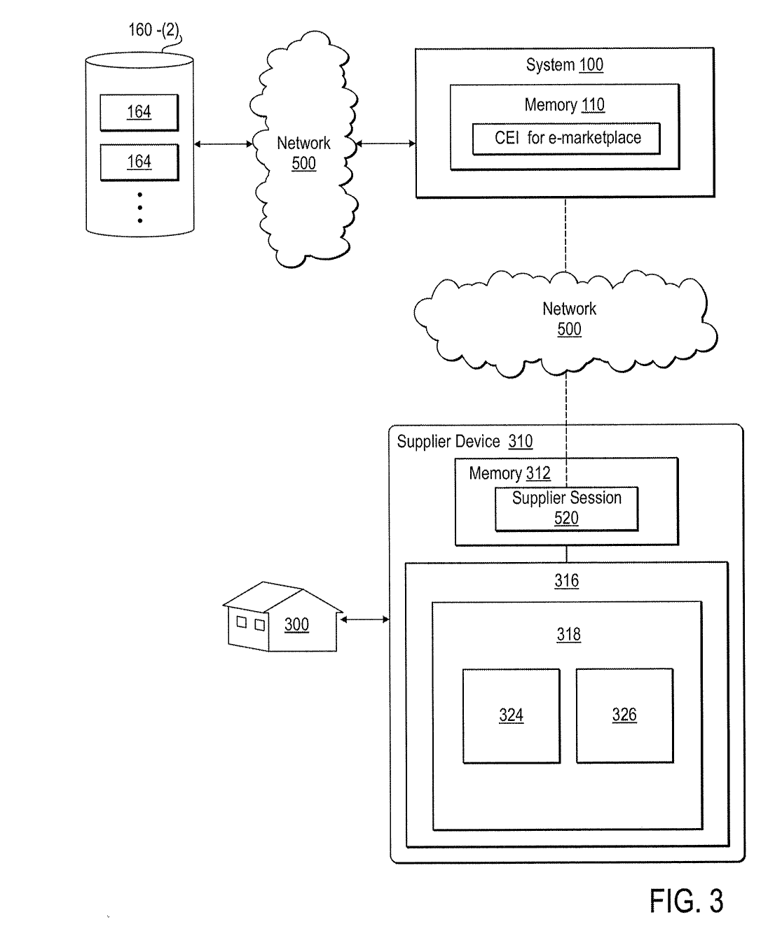

FIG. 3 shows a block diagram of a supplier device 310 according to some examples of the present disclosure. As previously described, the supplier device 310 may be associated with a supplier 300 and may include a display 316. A supplier 300 may use the supplier device 310 to communicate with the system 100, which hosts the electronic marketplace 500. During normal operation, a supplier session 520 may be established in the memory 312 of the supplier device and information may be exchanged between the supplier device 310 and the system 100 for the duration of the supplier session 520. During a supplier session a supplier interface 318, which may be web-based or a dedicated GUI, may be displayed on the display 316 of the supplier device. The supplier 300 may provide and view information to and from the system 100 using the supplier interface 318. For example, the supplier may upload product information 164 via a product management interface 324 about any of its products. The product information may be stored in a product database 160-(2) communicatively coupled to the system 100 via network 500. The supplier 300 may also view analytics about the performance of its products (e.g., sales, likes, shares of its products in the marketplace) via an analytics interface 326 and/or may target advertising campaigns based on analytics generated by the system 100.

Products displayed by the system 100 may include any number of item features, collectively referred to herein as product information 164, which may be used by system 100 to predict preferences for the users and/or provide recommendations for products thereto. Item features may include, without being limited to, price, sex (e.g., for male, for female), age (e.g., for toddler, child, teenager, adult), material (e.g., cotton, wool, polyester, etc.), style category (e.g., business, casual, business casual, sportswear, swimwear, denim), subcategories within each style category, product category (e.g., clothing, accessory, book, sports equipment, automobile), product sub categories (e.g., type of clothing—shirt, dress, pants, etc.; type of car—SUV, convertible, etc.), brand, average rating, number of ratings, number of times recommended, number of times viewed, date introduced, number purchased since introduced, number purchased over a period of time (e.g., any given week, month, etc.), average time per view, and others. Item features for each product may be stored in a product database 160-(2) (also referred to as item features database), which may be implemented in the storage 150 of system 100.

When a new product is added to the electronic marketplace 500, the product database 160-(2) may be updated to include the product information 164 (e.g., item features) for this new product. A supplier may provide certain information about the product and certain ones of the item features in the database may be populated based on this information. Other information may be obtained over time and may be based on interaction of the users within the electronic marketplace (e.g., number of times viewed, features relating to ratings of the product, etc.). Thus, certain item features may accordingly be updated continuously or periodically as described herein.

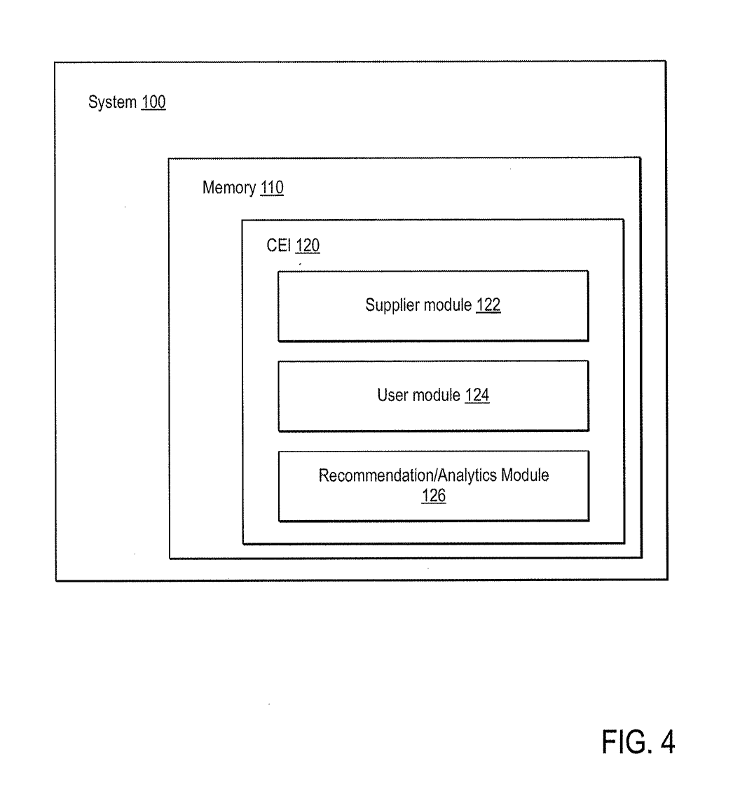

FIG. 4 depicts a block diagram of a memory 110 accessible to the system 100 according to some examples of the present disclosure. As described above, the memory 110 may include computer-executable instructions 120 causing the system 100 to implement an electronic marketplace according to the present disclosure (e.g., the system 100 may be programmed to implement an electronic marketplace as described herein). The instructions 120 may include computer-executable instructions, which when executed program system 100 to perform some or all of the functions described herein. For example, the instructions 120 may be instructions for performing functions associated with the electronic marketplace 500. The computer-executable instructions 120 may include instructions 122 for performing functions related to supplier interaction within the electronic marketplace. The instructions 122 may also be referred to herein as a supplier module 122. The computer-executable instructions 120 may further include instructions 124 for performing functions related to user interaction within the electronic marketplace. The instructions 124 may be referred to herein as a user module 124. The computer-executable instructions 120 may also include instructions 126 for performing functions related to providing recommendations to the users and analytics to the suppliers. The instructions 126 may also be referred to herein as an analytics module 126. Other instructions may also be included in some or all of the embodiments of system 100.

The supplier module 122 may include instructions for displaying a supplier interface and receiving input from the one or more suppliers, as described above. The supplier input may include identification and/or authentication information of the supplier, product information, and ad campaign information, as will be further described. The user module 124 may include instructions for displaying a user interface and receiving input from the one or more users, as previously described. For example, user input may include identification and/or authentication information of the user which may be used by system 100 to grant the user access to the electronic marketplace. User input may also include rating received from a user, sharing of products with others, uploading of user-generated content, and placing products in the user's shopping cart. As discussed above, when a user places a product in his electronic shopping cart, a “request for offer feature” of the user may be updated and the supplier of that product may be notified, for example with a notification message or through analytics available to the supplier, of user's interest in purchasing the product.

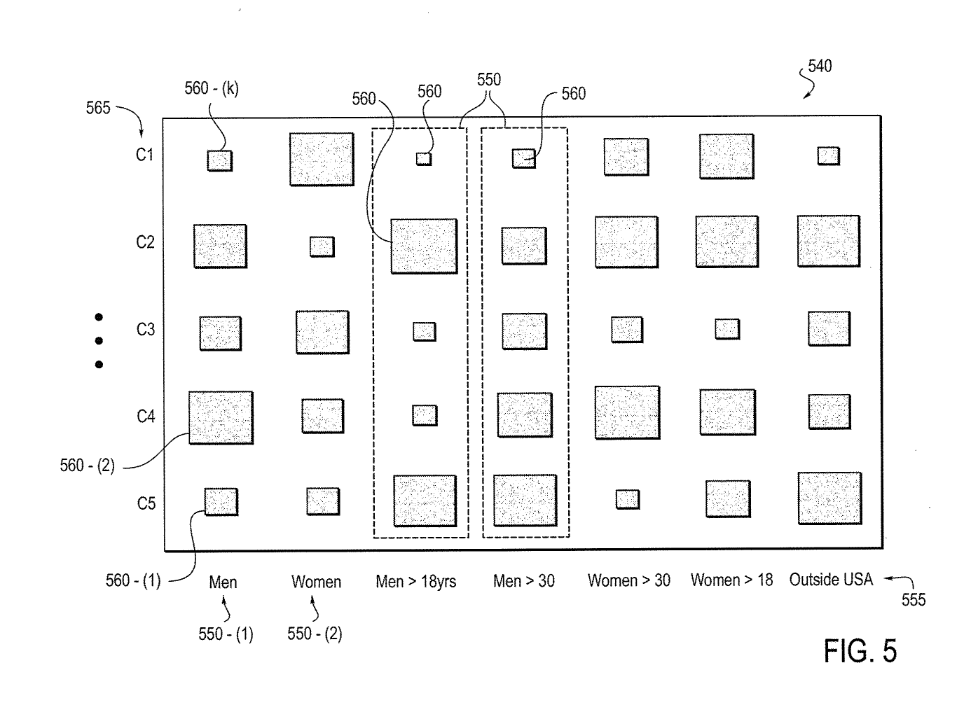

An example of the analytics module 126 will be described in further details with reference to FIGS. 5-7. The analytics module 126, also referred to herein in some examples as a recommendation engine 126, may include instructions for updating the product database, which, as described above, includes information about products or items available for sale via the electronic marketplace. Instructions for updating the product database may be executed any time interaction occurs with respect to an item. Generally, when an item is added to the marketplace and/or removed (e.g., sells out of stock), when the item is viewed, rated, shared, and/or purchased, the relevant item features in the product database may be updated to reflect these interactions with the item. The recommendation engine 126 may further include instructions for updating the user database, which may be executed when a new user joins the marketplace and/or when users interact within the marketplace (e.g., when a user rates an item, or requests a recommendation). When a new user joins the electronic marketplace 500, a user database update process may be triggered, which may cause instructions from the user management instructions to be executed to update the user database with a new profile entry. A new profile entry, which contains user features and preferences for the new user, may be created and stored in the user database. The recommendation engine 126 may further include instructions for receiving ratings, instructions for generating recommendations, instructions for clustering users, and/or instructions for generating affinity data, which may be provided to the suppliers.

Instructions for generating recommendations may be implemented as a recommendation methodology that balances known user behaviors against calculated feedback strategies. Various techniques for balancing user behaviors against calculated feedback are known by those skilled in the art and may be used to implement a recommendation methodology according to examples of the present invention. The concept of balancing user behaviors against calculated feedback relates generally to the conflicting processes of balancing flexibility with efficiency. As may be understood by those skilled in the art, balancing user behaviors against calculated feedback strategies may relate to balancing exploratory techniques such as searching for new options, experimenting, and conducting research against techniques which may achieve static efficiency (e.g., refining existing procedures, doing the same things only better, and reaping value from what is already known).

In the context of the recommending content or items in an electronic marketplace (e.g., e-marketplace 500), the recommendation methodology may be adapted to learn from ongoing user activity. When new items are added to the electronic marketplace, it may be desirable to expose users to the new items in order to obtain information about how users with certain attributes and/or preferences react to these new items so as to improve performance of the recommendation algorithm over time. This aspect may be thought of as balancing known user behaviors. This aspect may be balanced against calculated feedback to obtain some desired level of positive outcome from the recommendation methodology. That is, overtime, as a new item becomes sufficiently rated (e.g., has been rated a certain number of times), if the item is frequently rated low by users, then the recommendation engine may be trained not to recommend that item to other users in general or to users having similar attributes and/or preferences. If the item has been rated generally well over time, then the recommendation engine may recommend this item consistently and/or may recommend the item to users having particular attributes and/or preference (e.g., similar to attributes/preferences of those users who have rated the item well). This aspect may be thought of as calculated feedback. As noted, the recommendation engine may be implemented to balance known user behaviors against calculated feedback techniques to simultaneously provide useful recommendations to users while learning and improving the recommendation process by periodically introducing new items for rating by the users.

For example, the recommendation engine may utilize modeling techniques in the field of probability theory to balance known user behaviors v. calculated feedback goals. In the context of the recommendation engine according to the present disclosure, any of a variety of probability theory modeling approaches may be used to determine which items to recommend to a user so as to maximize some payoff for the system. Initially, as the engine may not have been sufficiently trained on the payoff of certain items (e.g., as they are introduced into the marketplace), the engine may rely more heavily on exploitation, while it learns over time which items are more likely to result in a sale or conversion. A rating term and a weighting term may be included in data representative of the ranking of an item, which may be dynamically adjusted over time. The rating term may be representative of actual ratings of the item, while the weighting term may be indicative of whether or not the term has been rated only a few or many times.

The recommendation engine may be executed continuously or periodically to provide a recommendation to the user. For example, the recommendation engine may be initiated based on a trigger. The trigger may be a logging-in of the user into the electronic marketplace, an action of the user within the marketplace (e.g., a rating of an item, a sharing of an item with another member of the marketplace), a request from the user for a recommendation, an addition of a new item to the marketplace, or other actions in other examples. Prior to providing a recommendation, the recommendation engine may update the user's preferences (e.g., update the user preference vector in full or in part based on changes since the last recommendation). The user preferences may be updated based on recent changes to the user database and/or product database to include new items, updated features of existing items, new users and updates to users. The user preferences may be updated based on a predicted utility of the items to the user, which may be thought of as the calculated feedback term of the recommendation methodology. In some examples, the preferences may also be updated based on the known user behaviors term to allow the recommendation engine to introduce new items to the user.

The recommendation engine may down select items to recommend based on filtering, ordering/ranking of the items and other conventional techniques. For example, items may be filtered based on sex/gender, age, and other features. The items may be ordered based on their preference value to the user and only a select number of items having the highest preference value may be recommended to the user. Information about the items selected for recommendation by the recommendation engine may be displayed to the user within the user interface. A rating interface may also be included to permit the user to provide ratings for any items including the selected/recommended items.

The instructions for receiving ratings may include instructions for determining whether the user rated an item (e.g., testing to determine whether an input was received via a user rating interface), determining what the rating was for the item, and storing the rating in the item features or product database. The sorting of the rating may include updating the rating field if the item had previously been rated by the user with a different rating. The rating methodology may also trigger execution of the instructions for updating the user database (e.g., to update features and preferences for the user providing the rating) and/or may also trigger the recommendation engine.

As previously described the recommendation engine (e.g., analytics module 126) may also include instructions for generating analytics and/or graphical representations of same, which may be provided to a supplier for intelligently designing a marketing campaign. For example, the analytics module 126 may include instructions for clustering users and/or generating one or more cluster maps (e.g., the cluster map 540 shown in FIG. 5). A cluster map may be a type of a graphical representation of analytics generated by the system 100. Other graphical representation of analytics may include, without being limited to, heat maps, histograms, bar diagrams, scatter and/or line plots, and, pie charts. As described herein a subset of users from the plurality of users of the electronic marketplace may be identified and/or grouped in one or more clusters based on one or more attributes of the users and/or an affinity of the users for a product feature. In certain examples, a graphical representation of the clusters of users may be displayed. For example, the graphical representation may be a pie chart in which each cluster of the plurality of clusters is depicted as a slice of the pie chart. A relative size of each slice may be representative of the number of users in that cluster or slice relative to other clusters or slices of the pie chart. In some examples, all of the users of the electronic marketplace may be included in the pie chart if they meet the criteria for inclusion, while in certain examples, only a subset of users may be included. In other instances, a color and/or an alphanumeric value may be used to indicate information about the users assigned to a cluster (e.g., number of users assigned thereto) or provide additional information about the clusters. Instructions for clustering users may be implemented as a clustering methodology which may be configured to arrange, group, or cluster users in one or more clusters 550 and/or sub-clusters 560 based on one or more attributes and/or preferences of the users. The analytics module 126 may generate a cluster map 540 which may be a visual representation of groups of users that share common attributes and/or have similar preferences for features of products. The system 100 may include instructions for displaying the cluster map 540 on a display (e.g., a supplier display 316).

In some examples, recommendations and/or clustering of users may be performed by the system 100 based on part-worths, also known as part-worth utilities in conjoint analysis. Conjoint analysis or stated preferences analysis is a statistical technique which may be used in marketing or market research to determine how people value different features that make up an individual product or service. The analytics module of system 100 may be implemented to utilize principles of conjoint analysis and utilize the ratings, purchases or other interactions of users within the marketplace hosted by the system 100 to determine the “part-worth utilities” of individual features or attributes of products to a given user. In certain examples of the system 100, techniques other than conjoint analysis may be used for providing recommendations and/or clustering users. In the context of conjoined analysis, and as may be understood by those skilled in the art, the preference of a user for a combination or conjoint attributes of a product may reveal the “part-worth utilities” of the individual attributes of that product. Depending on the user's preference for one or more items having one or more combinations of attributes or features, the system may determine part-worth utilities for the individual features of products to a user.

Referring back to the example of the cluster map 540 depicted in FIG. 5, in certain embodiments, the system 100 may arrange users in clusters (e.g., clusters 550 and/or sub-clusters 560) based on one or more user attributes and/or one or more relative preferences of the users for particular product or item features or combinations of item features. The system 100 may arrange users into clusters 550 based on one or more first criteria 555. The system 100 may further arrange users into sub-clusters 560 based on one or more second criteria 565. The first and/or second criteria 555, 565 may be a user attribute (e.g., age, gender, location, or others) or combinations of user attributes (e.g., age and gender, age and location, etc.). The first and/or second criteria 555, 565 may be an item feature or combinations thereof. In further examples, the first and/or second criteria 555, 565 may include or be based on relative preferences of users for particular product features or combinations thereof. As will be understood any combinations of information stored by the system 100 as may be relevant for a particular supplier, product, or advertising campaign may be used for clustering of users by the analytics module 126. The first and second criteria 555, 565 for clustering users may be stored in the storage 150 and accessed by the analytics module 126 when clustering users.

Referring to the specific example in FIG. 5, the first criteria 555 includes a gender user attribute, combinations of gender and age user attributes, and location attributes. Users may be grouped according to the first criteria, for example users who are men may be assigned to a first cluster 550-(1), users who are women may be assigned to a second cluster 550-(2), and so on. As described above, the criteria for membership in a cluster may, in some examples, be a combination of user and/or product attributes, in this example, a combination of gender and age user attributes. It will be understood that the particular example depicted in FIG. 5 is illustrative only is not limiting.

Users assigned to the clusters 550 may be further subdivided by the analytics module 126 into the sub-clusters 560 (e.g., 560-(1), 560-(2), through 560-(k)), based on one or more second criteria 565 (e.g., C1-C5). Sub-clustering may provide further granularity of relevant information about these users. In some embodiments, the second criteria 565 (e.g., C1-C5) may include one or more item features. For example, the C1 criteria may be an item feature corresponding to color of the item, the C2 criteria may be an item feature corresponding to material of the item, type of clothing, or others, the C3 criteria may correspond to another item feature or combinations thereof, and so on. In further examples, the second criteria 565 may be a combination of an item feature and a range of relative preferences of users for the particular feature. As an example, the C5 criteria may be the combination of a particular material item feature (e.g., silk), and a relative preference for this feature exceeding a certain value (e.g., greater than 50%). As such, the second criteria C5 may correspond to a “preference for silk>50%.” It will be understood that any combination may be used for any of the first or second criteria and the criteria may be customizable by the system 100 and/or supplier (e.g., via the supplier interface 318). It will be further understood that additional sub-clustering according to additional criteria may be performed for further granularity of available user data. The analytics module 126 may assign users that match the second criteria C1-C5 to the respective sub-cluster, and users that do not match any of the first and second criteria may be left out of the cluster map. As such, the analytics module 126 may select a subset of the users of the electronic marketplace 500 for clustering in a given cluster map depending on the selected first and second criteria. The grouping of users into clusters may be visually represented using a multi-dimensional matrix. In the example in FIG. 5, clusters and sub-clusters of user profiles are depicted as a 2×2 matrix, with the first criteria shown along a first dimension (e.g., the x-axis) and the second criteria shown along a second dimension (e.g., the y-axis). Other techniques for visually representing the clusters may of course be used.

The cluster map 540 may be a graphical representation of analytics generated by the system 100 and may serve as a visual tool for a supplier by depicting user information that may be relevant to the supplier. For example, and as described above, the cluster map 540 may depict a subset of users from the plurality of users of the marketplace which may have an affinity or preference for products offered by the supplier. The analytics module 126 may include further instructions which when executed may cause additional information relating to the clusters of users to be displayed. For example, analytics module 126 may cause the relative membership (e.g., number of users within the individual cluster or sub-cluster) to be displayed on or adjacent to the cluster map 540. The relative membership may be displayed numerically. In some examples, the relative membership may be displayed using other visual cues instead of or in addition to providing the numerical value of the number of users in a cluster. For example, a size of a given sub-cluster 560 may correspond to the number of users assigned to that sub-cluster. The relative size of each cluster may visually inform the supplier of the relative membership of users within each cluster. As described herein, other graphical representations of analytics may be generated by the analytics module 126 of system 100.

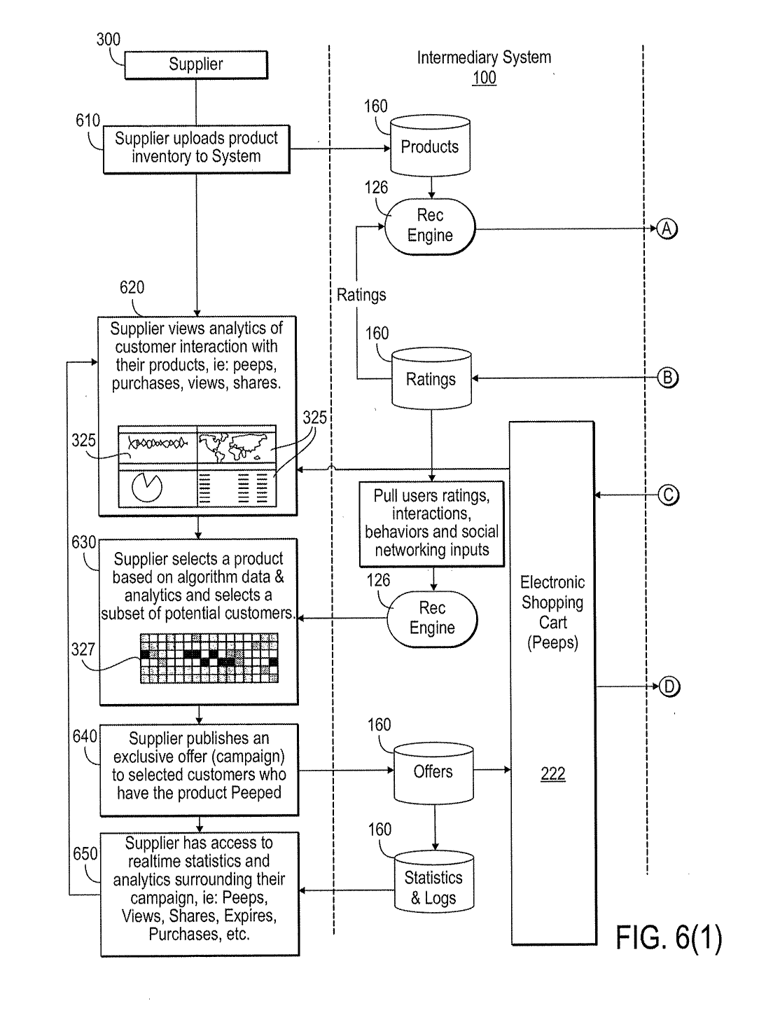

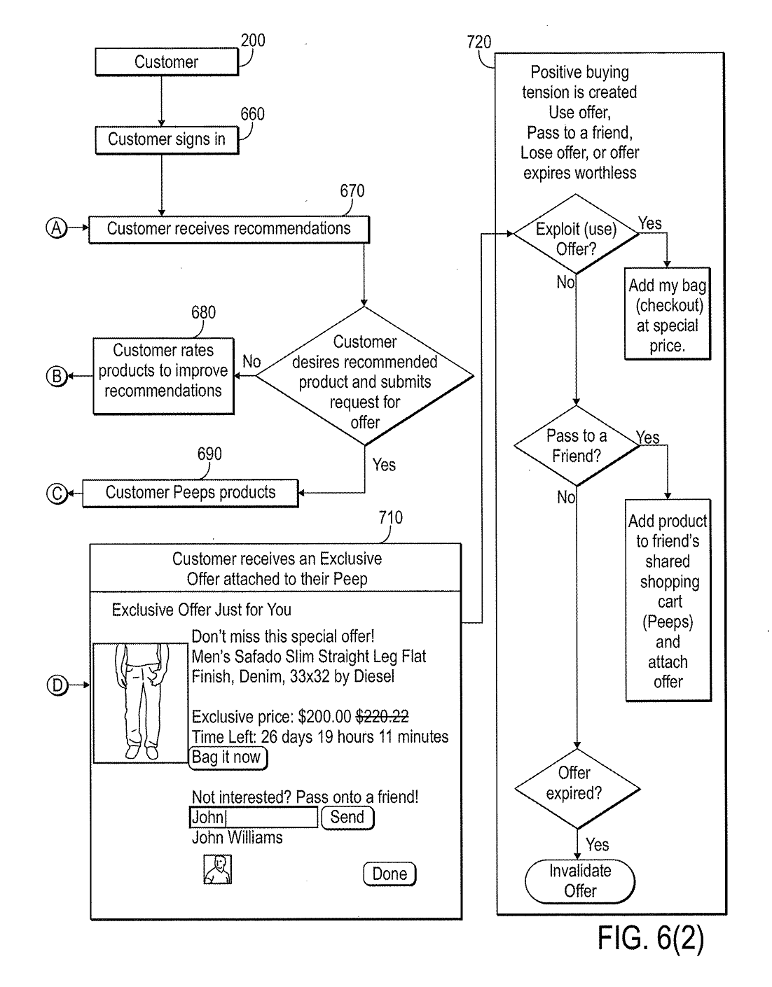

Referring now to the illustration in FIGS. 6(1)-6(2), a process flow according to examples herein will be described in further detail. During normal operation, certain activities or steps may be performed by the supplier 300. For example, the supplier 300 may upload product information to the electronic marketplace as shown in block 610, which product information may be stored in a database 160 managed by the system 100. Analytics generated by system 100 may be available and may be viewed by the supplier 300 using the supplier interface 316, as shown in block 620. As described herein, the supplier may view analytics, including, and without being limited to, information about number of likes, purchases, views, and/or shares of the supplier's products. The analytics may also include one or more graphical representations of clusters of users, which may be grouped together based on various attributes (e.g., user attributes and/or product features). The supplier may select a product, for example based on the analytics 325, for which the supplier may wish to initiate or launch a campaign, as shown in block 630. As further shown in block 630, the supplier may target the campaign to a select subset of users, for example based on affinity data 327 provided by the system. The campaign may be published and an instance of the offer associated with the campaign may attach to each user in the select subset of users, as shown in blocks 640 and 710 respectively. The campaign (e.g., a marketing campaign, advertising campaign, offer, or sale) may provide notification to one or more select users from the plurality of users of the marketplace of an exclusive price for the product, which exclusive price is only available to the one or more select users and for a duration of time which may be set by the supplier. The supplier 300 may monitor the performance of the campaign during and/or after the completion/expiration of the campaign. In this regard, the supplier may have access to real-time statistics relating to the campaign, as shown in block 650. The system 100 may generate, gather, and/or store the real-time statistics in one or more databases 160 of storage 150, which databases may be accessible to the supplier. The supplier may tailor future campaigns based on performance of the current and or previous campaigns.

Referring now to the user side of the flow diagram, during normal operation, a user 200 may log into the electronic marketplace as shown in block 660, and may interact within the electronic marketplace. For example, the user may receive recommendations, as shown in block 670, and the user may rate and/or “peep” items as shown in blocks 680 and 690 respectively. A customer may “peep” an item by indicating an affinity for the item (e.g., when a customer greatly likes and/or wishes to purchase a product). A “peep” may be accomplished by, for example, by selecting the item and placing the item in the user's shopping cart, or by any other mechanism for indicating affinity. In response to the customer demonstrating an affinity for the product, the system 100 may generate a “request for offer” (e.g., a request for offer feature may be entered into the user's profile or a request for offer tag of the user's profile may be toggled). Ratings, “peeps” and other interaction of the user within the marketplace 500 may be monitored, stored, and or used by the system 100 to provide analytics 325, including affinity data 327, to the supplier 300. As described herein, the analytics module 125 (e.g., recommendation engine 126 in FIG. 6(1)) may include instructions for monitoring user interaction within the marketplace, and for generating, gathering, and/or storing analytics, including affinity data 357, responsive to user interaction.

As described herein, a system 100 according to the present disclosure may include instructions for receiving input from one or more users of the electronic marketplace and for providing recommendations to the same or different users of the electronic marketplace based on received input (e.g., preferences of the one or more users for particular product attributes). For examples, the one or more processing units of the system 100 may be programmed to receive input from a first user (e.g., likes, peeps, shares, and/or ratings of one or more products) and may store the input of the first user. The system 100 may then provide a recommendation, contemporaneously or at a later time, to the first user based on the input from the first user. In further examples, the system may provide a recommendation to another user based on the input received from the first user. In some instances, the system 100 may be configured to use predictive modeling techniques to extrapolate relevance of a product or one or more product features to the second user e.g., based on similarities of attributes of the first and second users. The system 100 may take into account inputs from the second user when providing recommendations to the second user, in addition to or instead of basing the recommendations to the second user on input from the first user. As will be understood, this may apply to any combination of users of the electronic marketplace. That is, input from one or more users of the electronic marketplace may be used to provide recommendations to other one or more users of the electronic marketplace.

Referring again to FIGS. 6(1)-6(2), a supplier may launch a campaign, for example as shown in block 630, by utilizing the supplier interface 316 to identify a product or products for inclusion in the campaign. The supplier may further utilize the analytics to identify a user or group of users to receive an exclusive price point defined by the campaign. A supplier may launch a campaign, for example as shown in block 630, by utilizing the supplier interface 316 to identify a product or products for inclusion in the campaign. The supplier may further utilize the analytics to identify a user or group of users to receive an exclusive price point defined by the campaign. The supplier may specify an exclusive price point for one or more products, and duration of the campaign. These parameters may be received by the system 100 and stored in one or more databases 160.

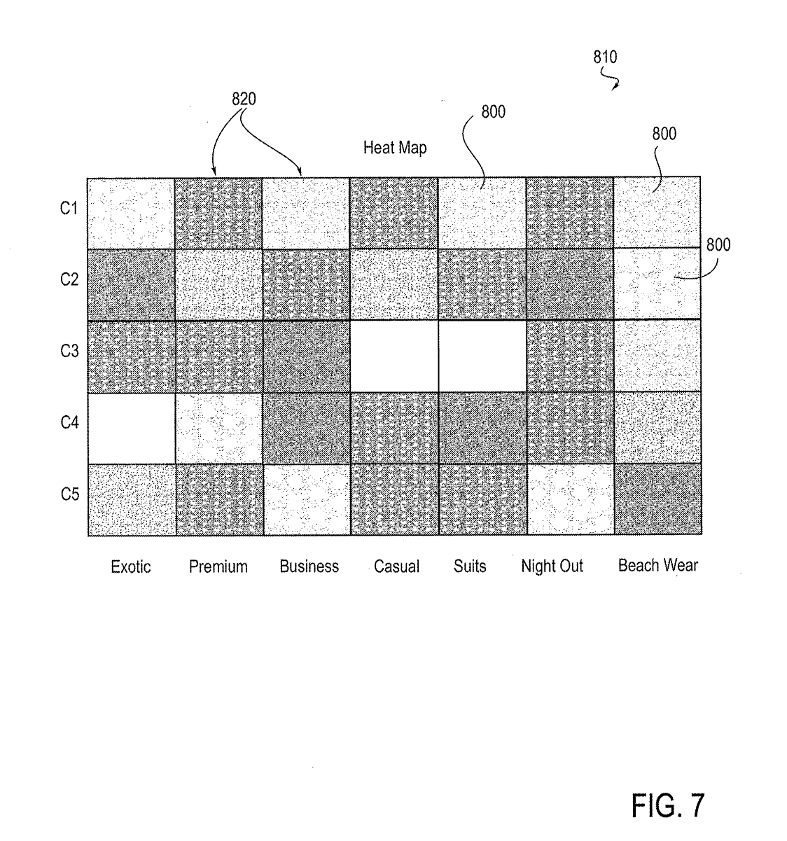

The system 100 may enable the supplier 300 to intelligently target the campaign by providing analytics, including the affinity data described herein. In this manner, the supplier may down select and target its campaign to users which have expressed a high interest or desire to purchase the product. In a sense, the supplier may have visibility to the user's electronic shopping cart 222 and may be able to extend offers to those users who are more likely to purchase the product rather than expend marketing resources to all users at large, including users which may have little or no interest in the product. As noted above, the analytics module 126 may include instructions for generating and/or displaying affinity data 357. The affinity data 357 may include a visual representation of clusters of users which are grouped together based on their affinity for a particular product and/or product feature. For example, the analytics module 126 may include instructions for generating and displaying an affinity data map, which may be implemented as a heat map 810 as shown in FIG. 7. The system 100 may display the heat map 810 such that users are assigned to groups 800 based on one or more categories. The categories may be user features, product features, user preferences, or combinations thereof. The categories may be customizable for each supplier and/or each product of the supplier. In some embodiments, the categories may be similar to any of the first and/or second criteria 555, 565 described previously with reference to FIG. 5.

The supplier may utilize analytics provided by the analytics engine to identify the user or group of users to target with the campaign, e.g. by selecting one or more regions of example heat maps described herein. For example, the supplier may select all regions of a heat map having an intensity greater than a particular level. The system 100 may generate affinity data 357 in response to the supplier selecting a product for which the supplier may wish to initiate a campaign. The affinity data may include one or more affinity indicators 820, each corresponding to a group of users 800. The analytics module 126 may compute affinity indicators 820 associated with each of the respective groups 800 and may cause the affinity indicators 820 to be displayed on or adjacent to the heat map 810, for example as a numerical value, a color, or other visual indicator. The affinity indicator 820 may correspond to a likelihood that the users assigned to the particular group highly desire and/or wish to purchase the product associated with the heat map 810. For example, and as shown in the embodiment in FIG. 7, shades of grey ranging from white to black may be used, with white representing lowest and black representing highest affinity value, and any number of shades of grey as may be needed to represent values within the particular range of affinity values. In this regard, the affinity data map 810 may function as a “heat map” and provide a user-friendly visualization tool for the supplier to determine which customers they may want to target with the campaign.

Generally, the analytics module 126 may include, in the affinity data map 810 for a particular product, users who have indicated an affinity for (e.g., “peeped”) that product. Users of the marketplace 500 who have not indicated an affinity for the product may be filtered out by the analytics module 126. As such, the analytics module 126 may down select information to be display to the supplier to information about users who are more likely to purchase the product. The analytics module 125 may use the “request for offer” attribute of the users' profiles to determine which users should be displayed in the heat map 810. That is, if a user had indicated an affinity for a product and thus generated a “request for offer” the user may be selected for inclusion in the heat map 810 for this particular product.

A supplier may publish an offer or launch a campaign by selecting a target group of users and/or providing information to the system 100 relating to the offer. The supplier may select a group 800 for targeting a campaign thereto by selecting one of the regions, e.g. one of the squares shown in FIG. 7, via the supplier interface 316. The selection may be made by, e.g., highlighting or clicking on the square, selecting a check box next to the square (not shown), or inputting text via the supplier interface 316. Other mechanisms for selecting a group of users may be used. Responsive to the supplier selection (e.g., upon receipt by the system 100 of an indication from the supplier of a target group for an exclusive price point), the system 100 may generate data to cause an offer corresponding to the exclusive price point to be communicated to each of the users within the selected group. The system 100 may communicate the offer by e.g., transmitting a notification to each user and/or by displaying the notification of the offer via the user interface 216 during the next or other subsequent user sessions (e.g., as shown in block 710). As such, in response to the selection by supplier 300 of one or more squares of the heat map 810, an instance of the offer may be attached to the profile of each user assigned to group(s) corresponding to the selected square(s).

Prior to publishing the campaign and/or selecting the target group, the supplier 300 may provide, via the supplier interface 316, additional information relating to the campaign. The additional information relating to the offer may include the exclusive price, the duration or expiration of the offer, as examples, which additional information may be stored in the database 160. Other information for intelligently and dynamically implementing a marketing campaign may be used in other example, e.g., the system 100 may enable the supplier to limit the number of transfers of the offer. In further examples, the system 100 may enable the user and supplier to bargain further, for example by enabling the user to submit a counter-offer via the user interface. In such examples, the computer executable instructions 120, which when executed cause the system 100 to perform functions associated with the electronic marketplace, may include further instructions, that cause the one or more processing units of the system 100 to receive a counter offer from one or more users that have been selected to receive the exclusive price (e.g., via a selection of a cluster of users by the supplier). In some instances, the counter-offer may operate as a rejection of the offer by the user and in such cases, in response to receipt of an indication of a counter-offer from the user, the system 100 may deactivate/invalidate the offer for this particular user.

Once parameters for the campaign are specified by the supplier, the system 100 may receive an indication from the supplier corresponding to a launching of the campaign. Responsive to the indication of a campaign, the system 100 may provide the exclusive price to the selected users, for example by generating data to cause users from the selected group(s) to receive a notification of the campaign. The system 100 may access the identity of users associated with the regions of the heat map selected by the supplier and may provide the exclusive offer to those users. The offer may be provided to the users by, for example, placing a notification such as a flag or other indicator on or in the vicinity of a picture of the product that may, for example, be displayed in the users' shopping carts. The users may highlight or click on the product to receive the offer. In other examples, the offer may be displayed to a user when the user logs in to the system. In some examples, items in the user's shopping cart 222 may be reordered to place items with exclusive price points at the top of the shopping cart. User that receive the exclusive price point may then purchase the item at the exclusive price point, share or gift the exclusive price point to a friend, or allow the price point to become expired, as shown in block 720. By exclusive price point it is generally implied that the specified price (e.g., a reduced price) is only available to a select group of users. Other users of the marketplace may not be able to purchase the item at the exclusive price if they have not received a notification of the offer e.g., directly from the system or as a share from another user of the marketplace.

The offer may be displayed in the manner shown in 710. For example, an image of the product may be shown, together with the exclusive price point. The system may provide one or more options to the user which may correspond to actions the user can take with respect to the offer. In the present example, three options may be provided to the user by system 100: accept the offer (e.g., buy the product), pass the offer along, or decline the offer. In some examples, the offer is stored in a database field in a database record associated with the user. For example, the offer may be stored in the user's profile 162 in a database 160 maintained by system 100. When the user indicates an intention to accept, pass along or decline the offer, a database field associated with the user and offer may be updated to reflect the selection. The user's profile 162 may be updated based on the user's selection. In this manner, the system 100 may allow the user to take only one of those actions (e.g., accept, pass along, or decline) for each offer available to the user. If the user attempts to take multiple actions (e.g., accept the offer and pass the offer along), the system 100 may not allow the user to do so, or the selection may be simply unavailable, responsive to the updated database entry in some examples.

To accept the offer, the user may provide an indication that the offer is accepted, e.g. by clicking on or touching an accept icon, or placing the item into a shopping cart for purchase and/or completing a purchase of the item at the exclusive price point. To pass the offer along, the user may provide an indication the offer will be passed on, e.g. by clicking on or touching a pass on icon, or moving the offer into a display region associated with another user (e.g., a folder, mailbox, or shopping cart of the other user). If the first user indicates an intention to share the offer (e.g., the first user indicates an intention to pass the offer along to a second user), the user profile of the second user may be updated to reflect the availability of the offer initially extended to the first user. The system 100 may request information regarding the second user to whom the first user will be passing the offer. The system 100 may utilize this information further in the analytics provided to the supplier in some examples. In some examples, the system 100 may limit the users to which the first user may pass the offer. For example, the system 100 may allow the first user to pass the offer along to any users included in the first user's social network. The second user to whom the offer from the first user was passed may then receive the offer when they next access the system, and/or may be provided with an email, text, or other notification of the offer. To decline the offer, the user may provide an indication that they are declining the offer, e.g. by clicking or touching a decline icon, or the user may simply allow the timer to expire.

The offer, as shown in block 710, may further include an expiration date or a timer, which may be a countdown timer. The countdown timer may be displayed and may count down from an available offer time specified to the system 100 by the supplier. The countdown timer may add a sense of urgency to the exclusive price point offered to the user. In further examples, the offer, as shown in block 710, may include indicator of the number of shares (e.g., passes) that may be permitted for the particular offer. Other parameters may be specified by the system and/or supplier and certain other limitations may be imposed on an offer to create a positive buying tension.

As described herein, systems according to the present disclosure may provide analytics to suppliers who may utilize the analytics to offer exclusive price points to one or more users. The users may receive the exclusive price point and may accept, pass along, or decline to use the offer. The number of users who perform each of those actions may be fed back through the system and used to update the analytics provided to suppliers. In this manner, suppliers may be able to better target exclusive price point offers, thereby “monetizing likes” in some examples.

Those of ordinary skill would further appreciate that the various illustrative logical blocks, configurations, modules, circuits, and methodologies described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system for facilitating electronic commerce between one or more suppliers and one or more users, the system comprising:
electronic storage having stored therein a plurality of electronic user profiles, each user profile associated with a user of an electronic marketplace;
at least one processing unit coupled to the storage; and
a memory coupled to the at least one processing unit and the electronic storage, the memory including computer executable instructions, which when executed cause the at least one processing unit to:
receive, from a supplier device, a selection of a product available for purchase through the electronic marketplace;
generate, in response to the selection, a graphical representation of a sub-set of users of the electronic marketplace, the graphical representation including a plurality of clusters and the users from the sub-set of users arranged in one or more of the plurality of clusters based on one or more attributes;
receive, from the supplier device, a selection of a cluster;
receive, from the supplier device, an exclusive price for the product; and
provide the exclusive price to each user from the selected cluster.

2. The system of claim 1, wherein the graphical representation includes an affinity indicator for each cluster, wherein the affinity indicator corresponds to an affinity of the cluster of users for a particular product attribute.

3. The system of claim 1, wherein the users from the sub-set of users are included in the sub-set in response to input received from the users in the sub-set indicating a desire to purchase the product.

4. The system of claim 1, wherein the memory includes further instructions, which when executed cause the at least one processing unit to receive a counter offer from one or more users from the selected cluster.

5. The system of claim 1, wherein the memory includes further instructions, which when executed cause the at least one processing unit to remove a user from the sub-set of users when the user removes the product from an electronic shopping cart of the user.

6. The system of claim 1, wherein the memory includes further instructions, which when executed, cause the at least one processing unit to transmit data to the supplier system to cause a processor of the supplier system to display the graphical representation on a display of the supplier device.

7. The system of claim 1, wherein the graphical representation comprises an array of clusters arranged in rows based on a first attribute of the users and along columns based on a second attribute of the users.

8. The system of claim 1, wherein the graphical representation includes an array or clusters arranged in rows based on a user profile attribute and along columns based on a product attribute.

9. The system of claim 1, wherein a visual size of each cluster in the graphical representation is indicative of a number of users assigned to the respective cluster.

10. The system of claim 1, wherein the graphical representation comprises a pie chart wherein each cluster of the plurality of clusters is depicted as a slice of the pie chart.

11. The system of claim 1, wherein the memory includes further instructions, which when executed cause the at least one processing unit to
receive, from a user device associated with a first user, a first user input, the first user input indicating a desire to purchase the product;
store the first user input in a user profile of the first user; and
provide a recommendation to the first user based, at least in part, on the first user input.

12. The system of claim 11, wherein the memory further comprises instructions, which when executed cause the at least one processing unit to:
receive a second user input, the second user input corresponding to a rating by a second user of another product;
store the second user input in the storage; and
provide a recommendation to the second user based, at least in part, on the second user input.

13. The system of claim 1, wherein the memory includes further instructions, which when executed cause the at least one processing unit to:
receive, from a user device associated with a first user, a first user input, the first user input indicating an affinity for the product;
store the first user input in the storage; and
provide a recommendation to a second user based, at least in part, on the first user input;

14. The system of claim 11, wherein the memory further comprises instructions, which when executed cause the at least one processing unit to:
display, on a display of the user device, a notification of an exclusive price for the product; and
display, on a display of a second user device, a second notification of the exclusive price responsive to input received from the first user.

15. A computer-readable medium having instructions stored thereon, which when executed by one or more processors, cause the one or more processors to:
display, in a supplier interface, information about a plurality of products provided by the supplier for purchase through an electronic marketplace;
receive, from a supplier, a selection of a product from the displayed plurality of products;
receive, from the supplier, a selection of one or more users from a plurality of users of the electronic marketplace, the one or more users selected based on one or more user profile attributes, preferences, or combinations thereof; and
electronically communicate an exclusive price point for the selected product to the selected one or more users to allow the one or more users to purchase the product at a price different than a price available to other users of the electronic marketplace.

16. The computer-readable medium of claim 15 further comprising instructions, which when executed, cause the one or more processors to arrange the one or more users in a plurality of clusters based on one or more user profile attributes, product features, preferences, or combinations thereof, and display the clusters in the supplier interface.

17. The computer-readable medium of claim 16 wherein the selection of one or more users comprises a selection of a cluster from the plurality of clusters.

18. The computer-readable medium of claim 16, wherein the clusters are arranged in rows based on a first criteria and arranged in columns based on a second criteria different from the first criteria.

19. The computer-readable medium of claim 16 further comprising instructions, which when executed, cause the one or more processors to display, in the supplier interface, affinity data for the plurality of clusters, the affinity data comprising a plurality of affinity indicators, each affinity indicator associated with each cluster.

20. The computer-readable medium of claim 19, wherein each affinity indicator is based on an affinity of the users in a particular cluster for a particular product feature.

21. The computer-readable medium of claim 15 further comprising instructions, which when executed, cause the one or more processors to receive an input from a first user from the selected one or more users, and electronically communicate the exclusive price point to a second user from the other users in response to the input received from the first user.

22. A device comprising:
a display;
at least one processing unit; and
a memory encoded with instructions to cause the at least one processing unit to display an interface on the display to enable a supplier to:
select a product from a plurality of products in an electronic marketplace;
visualize information received from a server hosting the electronic marketplace about a plurality of users interested in purchasing the product;
select a group of users from the plurality of users, wherein the selection is based in part on the received information about the plurality of users interested in purchasing the product;
specify parameters of an advertising campaign, including an exclusive price for the product; and
transmit the parameters to the server for providing the exclusive price to each user from the selected group of users.

23. The device of claim 22, wherein the information about the plurality of users interested in purchasing the product includes a graphical representation of affinity of the plurality of users interested in purchasing the product to one or more product features of the selected product.

24. The device of claim 22, wherein the graphical representation of affinity is a heat map comprising clusters of users, the users clustered based on one or more user attributes, product features, preferences, or combinations thereof, and wherein the memory is encoded with further instructions to cause the processor to display the heat map on the display and enable the supplier to select the group of user by clicking on a region within the heat map.

25. The device of claim 22, wherein the memory is further encoded with instructions to cause the at least one processing to:
display performance data for the advertising campaign,
enable the supplier to specify parameters for a second advertising campaign based in part on the performance data; and
publish the second advertising campaign to the server for generating one or more notifications of exclusive price points in accordance with the specified parameters for the second advertising campaign.
